(19) United States
(12) Patent Application Publication
(10) Pub. No.: US 2020/0211028 A1
(43) Pub. Date: Jul. 2, 2020

(54) PAYMENT CONTROL SYSTEM

(71) Applicant: DIAMOND PAUL OKIEMUTE UJU, LAGOS (NG)

(72) Inventor: DIAMOND PAUL OKIEMUTE UJU, LAGOS (NG)

(21) Appl. No.: 16/232,385

(22) Filed: Dec. 26, 2018

(51) Int. Cl. G06Q 20/42; G06Q 20/40; G06Q 20/38; G06Q 20/36; G07F 19/00

(52) U.S. Cl. CPC G06Q 20/425; G06Q 20/4014; G07F 19/21; G06Q 20/3674; G07F 19/207; G06Q 20/3821

(57) ABSTRACT

The present invention provides a system for operably adapting a tiered level of protection for an owner or authorized user of a document or privilege by incorporating a confirmation process that proactively prevents any secondary access to items of value.

### BACKGROUND

In this fast-paced society and in the wake of the many conveniences of society, more and more opportunities are being created to make the dispensing of cash and similar tokens as easy as practical. In the normal progression of ease of delivery, debit cards or other instrument of dispensation are more and more readily available and accessible to the population. It is therefore easy to imagine that debit card losses are so rampant. Society unfortunately is presented with people who would not respect the right and genuine ownership of property. These unseemly characters are wont to steal a card or related information at the easiest opportunity and would use same to drain most or all of the cash off an account.

In some instances, misplacement of debit cards happens at point of sale locations or just as a process of living, shopping and more! In some instances, the owner of the card does not realize this loss until something bad happens—checking the balance on account, returned or unpaid items drawn on the account, or the like. At the latter check or assessment, the funds may already have been syphoned from the account or at least enough damage done that playing catch-up is painful, frustrating, and worrisome, to say the least. It would be beneficial if there is a process to prevent the “medicine-after-death” circumstance.

Other instances can include the origination and confirmation of wire transfers. As imaginable, wire transfers typically comprise the relocation of large amounts of money. Such process that funds leave from an issuing bank to a receiving bank takes time for confirmations and security of transactions. In instances, wire transfer may be delayed for a lengthy period of time because the needed confirmations are not in place. There is need to have a system that can confirm or invalidate a transaction in a timely manner—to facilitate commerce and more in an increasingly fast-paced society.

From the foregoing and more, it will be appreciated that what is needed in the art is a system or fix that prevents the unauthorized withdrawal of cash from an account or the unpermitted access to personal information, saving the rightful owner from undue anguish or pain. Such system is disclosed and claimed herein.

### SUMMARY

In one embodiment, the present invention provides a system for controlling of access to valuable information or resource, wherein a user of such access control instrument is subject to the actual owner or authorized user before a transaction is executed, wherein the use of a secondary confirmation scheme and capacity to ward off interloping use provide optimized protection for the stored or deposited resource.

### BRIEF DESCRIPTION OF THE DRAWINGS

FIG. 1 illustrates a payment point control system according to the present invention.

FIG. 2 illustrates a dual-ended point to point payment control system according to the present invention.

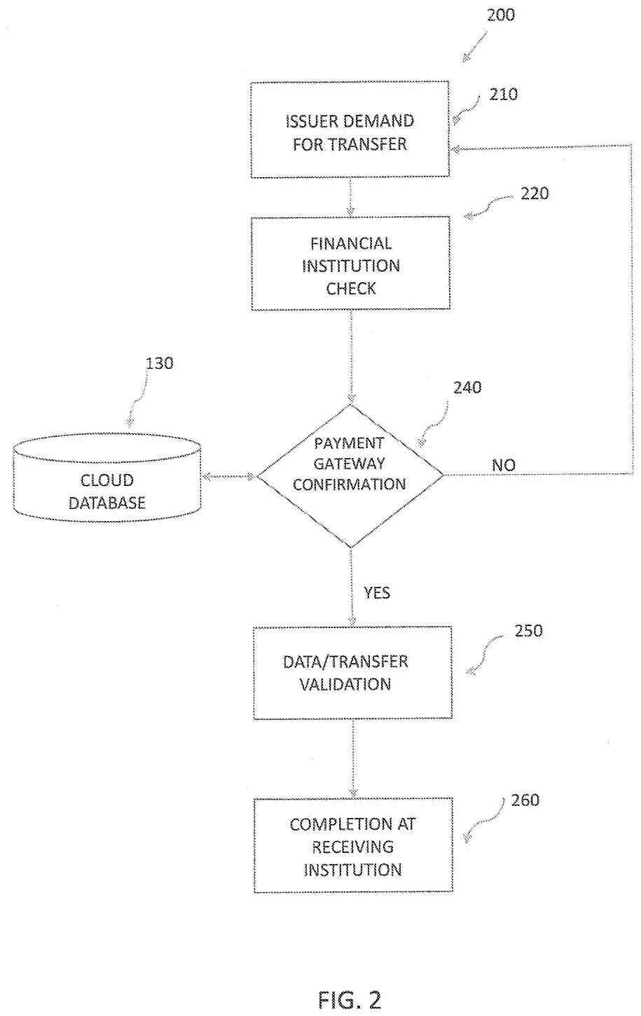

### DETAILED DESCRIPTION

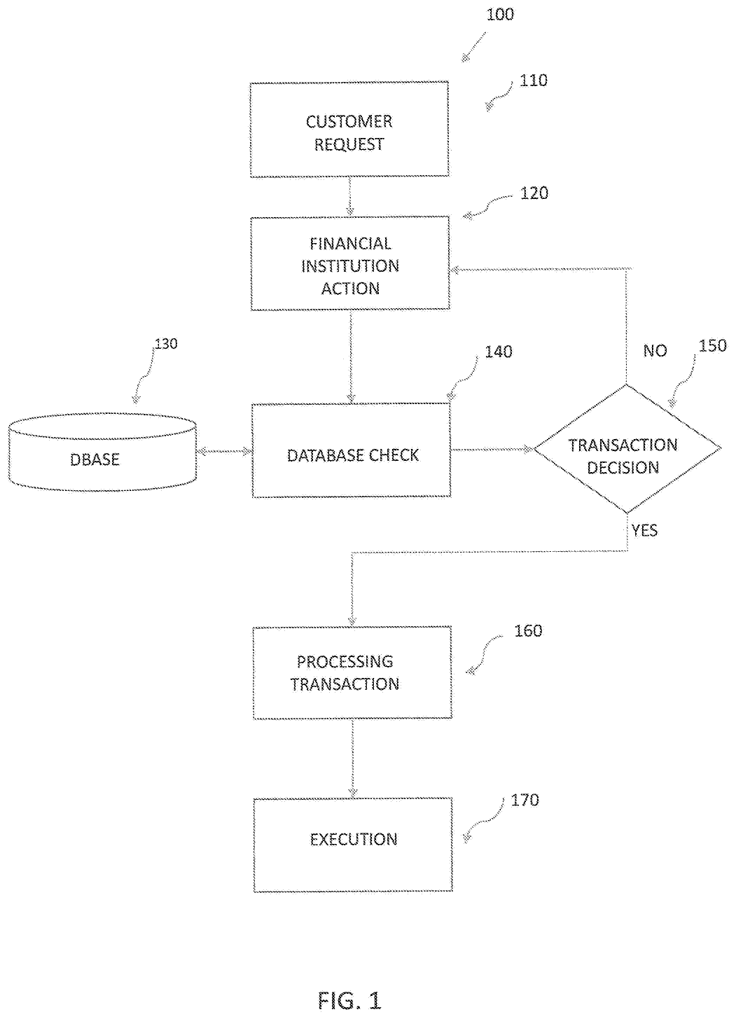

Referring to FIG. 1, a flow process 100 illustrating elements for the payment control system according to the present invention wherein a trigger point is shown when a customer or an account holder 110 requests or initializes a request of a financial institution 120. This request activates a transaction that preferably is executable in a remote or cloud-based environment wherein most transactions are done without the physical presence of the initiator or account owner, except that the base of the transactions is a financial institution 120. Such financial institutions 120 may be a bank, credit union, brokerage facility or any such other institution with capacity to lodge a customer's funds and move or dispense any or all of such funds to a different location, person or facility. An example is a typical banking transaction which may include withdrawal of funds at an Automatic Teller Machine or a transfer from one account to another. It may preferably include authorizations by a third party under the direction of an account holder or customer of the financial institution.

A customer 110 initiates a request or transaction linking to a checking step of an account record 140 or database of customer account information. Such transaction initiation may be evaluated or analyzed via an already stored information, preferably prepared and submitted in a cloud environment database 130 and linking up the account owner or customer 110 to the network cloud database 130 to an issuing financial facility 120 for a particular transaction. When and if there is a discrepancy or uncertainty in the transaction as presented as the reference is made to the customer 110 or database 130 via any control process now in place or later developed as compared with the referenced information in the database 140, the account owner or customer 110 may immediately or upon being alerted, stop such transaction 150 from occurring or being further processed. This proactive step is beneficial as it prevents any illegal or unauthorized transfer without certainty of process. The benefit of the present invention is the determination and action proactively before any disbursement is effected via a feedback loop with the account owner or customer 110. If in the unlikely circumstance that an error in transaction is noted in the decision-making step 150, such as improper password or access code, the transaction may recirculate to provide a second or repeated effort at completing the transaction in step 120. Once determined that the transaction was not authorized or is subject to potential or real fraud, the ATM card or other instrument utilized may effectively be seized by the ATM system or financial entity.

When the requisite portion of the transaction is approved 150, the instantaneous completion of the transaction 160 is pushed through the system for execution 170. When there is no need for an instant action, the processing 160 may follow a routinized process for execution 170. This process can be effective for letters of credit wherein other functionaries of an entity may be positioned to execute transactions that may end up as premature or unauthorized. The system of the present invention extends control for the process beyond the financial institution and incorporates the account owner 110 in the process. As disclosed above, the process of preventing an account from being victim of unauthorized or inappropriate withdrawal may be incorporated to effectively truncate a transaction that would have ended up with the release of funds. Once documents are provided for approvals as a confirmation that terms of a letter of credit or other conditional fund release instruments, the approval and release, even if automatic are electronically confirmed by the owner of the account, or such authorized agent before completion of such transaction.

Banking alerts for transactions are typically issued after the fact. A transaction that drains funds or unduly withdraws funds from one account to another gets approval prior to the transaction as against being done after the fact according to the teachings of the present invention. In an embodiment of the present invention, an issuer or initiator 210 utilizes the services of an originating or paying financial institution 220 for a transaction that procedurally is being routed through the cloud network 230. The transaction is then routed through a payment gateway configuration 240. Payment gateway systems and configuration vary according to location and jurisdiction. In the international money management system, there are payment gateways complimentary to SWIFT, ACH processes; wherein such payment gateways should be able to communicate and relay information as appropriate for the completion of transactions, or such similar gateway process that provides for communication between entities that pay or receive funding. At the gateway procedure, an issuer confirming officer is preferably presented with the opportunity to approve or reject the transaction. Once approved, such transaction is validated in the cloud-based system at the receiving financial institution for onward disbursement to the beneficiary. The validation or approval of the transaction 250 may be accomplished when all requisite information about the authenticity of the transaction is confirmed. Funding or transfer of funds completes the process 260 for the beneficiaries and the confidence of the parties to the transaction.

In use, a debt card is preferably inserted into the Automatic Teller Machine (ATM) slot at a first location. Once this process is executed, an alert, either by text or tone is relayed to the owner or authorized link for the card so inserted at the first location. In instances wherein, the use of the card is not authorized, any transaction on the card will preferably not be allowed to continue whether or not the user of the card has the PIN code. Such protection and control avert and prevent use of the card in instances of compromised PIN or related access codes. The ATM or location wherein the debit card was used would withhold said card for the rightful owner or one authorized to use it.

In the case of fund transfer such as wire transfer or guaranteed funds release, the transaction would by necessity preferably not be completed without the text (SMS) or tone confirmation by the owner or authorized user. Since wire transfers are made across interchange mechanisms or networks, the approval or denial of same would be preferably facilitated by that network to the discretely with the authorized user or owner of the account.

The present invention provides an instant or pre-transaction alert to the owner or authorized agent of the account prior to the transaction taking place. This process active preferentially to prevent loss and the attendant resources usable for recovery because of the timing and stage of the preventive step according to the present invention. The alert provided to the account owner in accordance with the present invention may be encrypted for needed security and to prevent under loss or improper transfer to anyone unauthorized to possess such information. The system of the present invention may be extended to users or owners of other personally identifiable information which may be stored in a location that should be secure and safe, wherein any unauthorized access can cause more damage than actual cash withdrawal. One can imagine codes that are useful for secure transactions being stored or held in a depository for later retrieval. If an unauthorized user gains access to an entry document such as door passes or safe security box location; such entry would not amount to a loss of information since the authorized user or owner of a stored information or valuable would preferably need to authorize the secondary access to the actual valuable—be it funds, jewelry, codes, or the like.

In the global financial space, wherein orders are continually executed for the benefit of the parties to a transaction, constant confirmations are needed before resources are caused to be transferred from one party to another. In most of these circumstances, an originator may present demand documents at one facility needing confirmation and execution from another facility. These instances typically demand a phone call or some direct conversation with an account officer or account owner. It is reasonable that transactions are not approved or executable without the account owner, implying that a member of a financial institution may not be able to independently authorize a transaction without the knowledge of the account owner. The present invention provides a method of pinging or alerting the account owner for an instant or immediate confirmation prior to completion and execution. In some instances, the need to confirm may be triggered by a preset account limitation or instruction determined between the account owner and the financial institution. A coded or set process eliminates the time wasted prior to approval of the transaction and completion is facilitated. The present invention discloses the messaging back and forth the owner of the account is preferably executed discretely and without knowledge of the benefiting third party, preventing fraud or theft.

The discrete nature or manner of communication between the location of interest and the owner or authorized user of a protected resource is a hallmark of this disclosure. When an interloper gains access to a card or other entrance apparatus, such access would preferably be very limited under the disclosure of the present invention, as the interloper would need, at any point of use, an immediate confirmation of the actual owner before any action that may be found to be a detriment to the owner.

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

What is claimed:

1. A payment control method, comprising:
a proactive control of access to valuable information or resource, wherein a user of such access control instrument is subject to the actual owner or authorized user before a transaction is executed, wherein the use of a secondary confirmation scheme and capacity to ward off interloping use provide optimized protection for the stored or deposited resource.

2. The payment control method of claim 1, wherein funds are proactively approved by the account owner before dispensation.

3. The payment control method of claim 1, wherein the owner of the account is notified by tone or Short Message System.

4. The payment control method of claim 1, wherein the ATM card is seized by the financial institution if discrepancies are detected.

5. The payment control system of claim 1, wherein the codes suitable to authorize a transaction are only available to the account owner.

6. The payment control system of claim 5, wherein the codes are encrypted.
